(19) United States
(12) Patent Application Publication
(10) Pub. No.: US 2011/0220463 A1
(43) Pub. Date: Sep. 15, 2011

(54) DEVICE FOR GRIPPING PET BOTTLES HAVING A PUSHER BODY

(75) Inventor: Andreas Fahldeck, Idar-Oberstein (DE)

(73) Assignee: KHS GmbH

(21) Appl. No.: 13/120,976

(22) PCT Filed: Apr. 24, 2009
(86) PCT No.: PCT/EP2009/003004

§ 371 Date: Mar. 25, 2011

(30) Foreign Application Priority Data
Nov. 3, 2008 (DE) 102008055620.3

(51) Int. Cl. B65G 47/86; B67C 3/24

(52) U.S. Cl. 198/617; 294/106; 294/198

(57) ABSTRACT

The invention relates to a device for gripping containers and bottles (3), particularly PET bottles, in container handling systems, such as in filling systems, particularly for transitioning and transferring from star to star, or to a filler, a rinser, or the like, having a drive and actuator bringing about the opening and closing of the gripper arms (4a, 4b), particularly designed as a pusher body (7), wherein the device for gripping is made substantially of two component assemblies. The first component assembly comprises those components that are subject to severe wear, and the second, machine-side component assembly comprises components that are subject to no or nearly no wear. The first component assembly is pivotally supported on the second component assembly and easily removably connected thereto.

The invention relates to a device for gripping PET bottles of the genus specified in the preamble of claim 1.

Various developments of grippers of bottles or other vessels in filling systems are known, for example in utility patents DE 297 13 510 U or DE 20 2006 018 379 U, where an actuating end is associated with each of the gripping ends of the two gripping arms by interposing a pivoting joint, between which actuating ends, for example, an eccentric cam or the like is rotatably mounted in order, in this manner, to effect an open position or a closed position. Deformable plastics material gripping arms are known in DE 20 2006 004 641 but they do not have their own driving means for active movement.

It is the object of the invention to create a solution by means of which in particular those components of the gripping device according to the invention that are subject to wear can be easily installed and removed without requiring the use of additional tooling.

This object is achieved using a device of the aforementioned type in that the components that are subject to wear, in particular the gripping arms and the pusher body with linkage surfaces that move the gripping arms, are combined in one common component assembly and are associated with one common bearing element, the bearing element being detachably connectable to the corresponding system element, such as the flushing machine or the like, by means of a locking connection.

The central concept in this case, therefore, is that the gripping device comprises two component assemblies, the first component assembly including the components that are subject to severe wear and the second machine-side component assembly including those components that are not subject to any wear or are subject to almost no wear. In this case, the first component assembly is pivotably mounted on the second component assembly and they are interconnectable so as to be easily separable. The connection is ideally performed without tooling, that is to say manually.

The term wear parts or parts that are subject to wear refers to those parts that in the course of their service life in an overall system have to be changed in a regular manner, e.g. after a fixed given number of actuations. Contrary to this are the constituent parts and components that are normally only exchanged in the service life of an overall system in the event of damage or a larger conversion and otherwise remain unchanged in situ and in this sense are fixedly connected to the device or the machine.

The achievement of the locking connection according to the invention between the gripping device on the one hand and the respective system element, such as, for example, a star or the like, is that each gripping device can be installed and removed individually in a rapid manner, something that can become necessary for instance when the provided service life is reached, if faults occur in the opening and closing mechanism or the like or a different size of container is to be conveyed.

One particular advantage is that even the regular replacement of grippers during operation on account of format changes is made considerably easier and is accelerated by the advantageous device according to the invention and its handling.

The invention allows practically all the essential elements that are subject to wear to be installed and removed completely as a unit, as said unit then includes, for example, abrading elements, guide bolts, elements that are made of plastics material on steel and the like and consequently can be replaced rapidly when worn or subject to similar defects.

All the elements that do not move substantially relative to one another remain on the corresponding system parts which means that, all in all, expenditure for installation and removal is reduced, as, according to the invention, all the wearing parts can be replaced rapidly without tooling.

One development according to the invention provides that locking clips for gripping and securing the gripping device are provided on the machine-side system element for the gripping device or on the side of the bearing element facing the machine element. With the locking clips according to the invention, irrespective of whether they are provided on the system element or on the gripping element itself, a simple cost-efficient coupling possibility can be achieved between the gripping device according to the invention on the one hand and the respective rail element or system element on the other hand.

If locking clips are provided on the system-side element, the invention then provides that said clips engage over a locking web on the bearing element, in reverse if the clips are provided on the bearing element of the gripping device, the invention provides that the clips engage in corresponding recesses on the machine-side system element.

The invention also provides conveying devices for, for example, PET bottles, said conveying devices being provided with gripping devices according to the invention.

Further advantages, details and features of the invention are produced on account of the following description and by way of the drawings, in which:

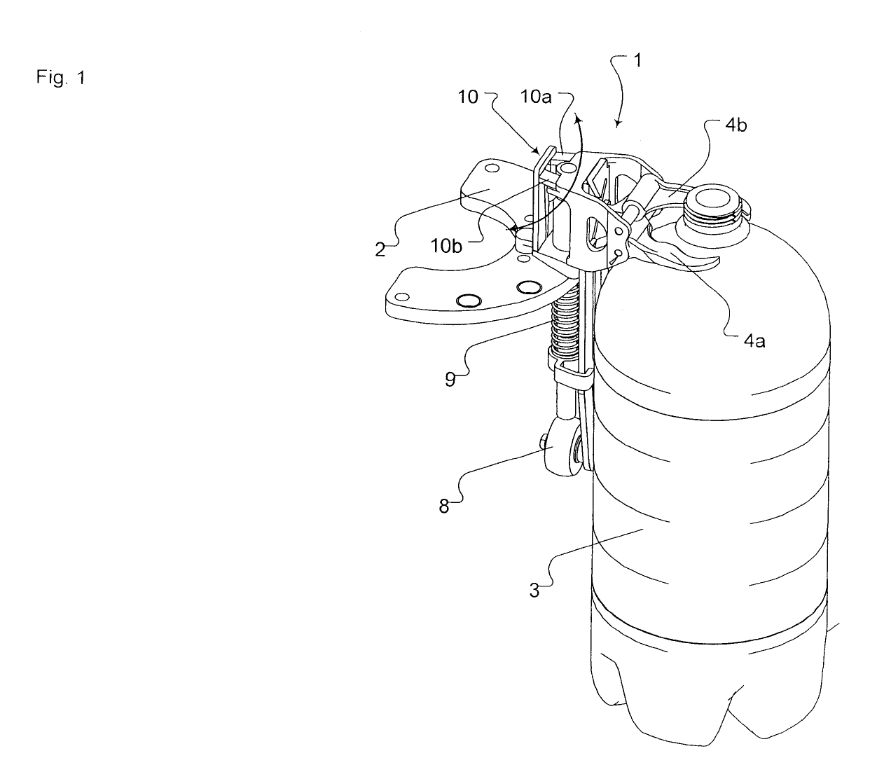

FIG. 1 shows the three-dimensional representation of an exemplary embodiment of the gripping device according to the invention;

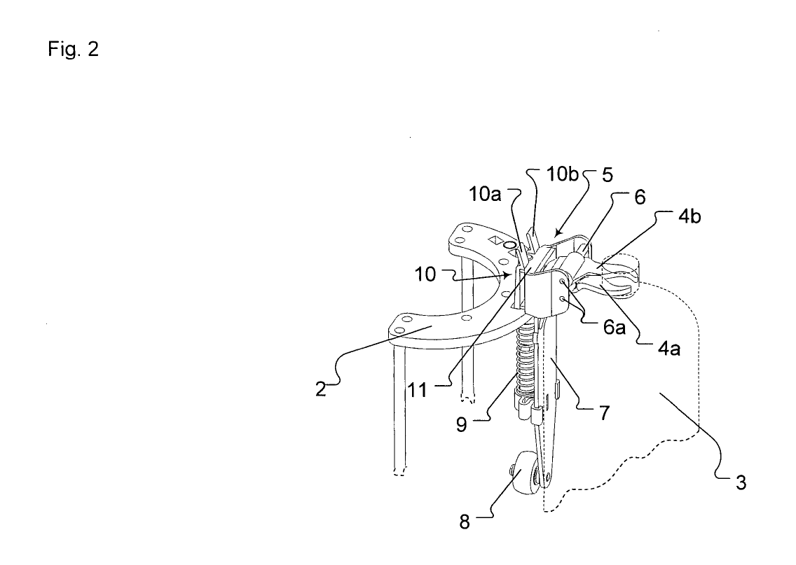

FIG. 2 shows a modified exemplary embodiment in an identical representation and

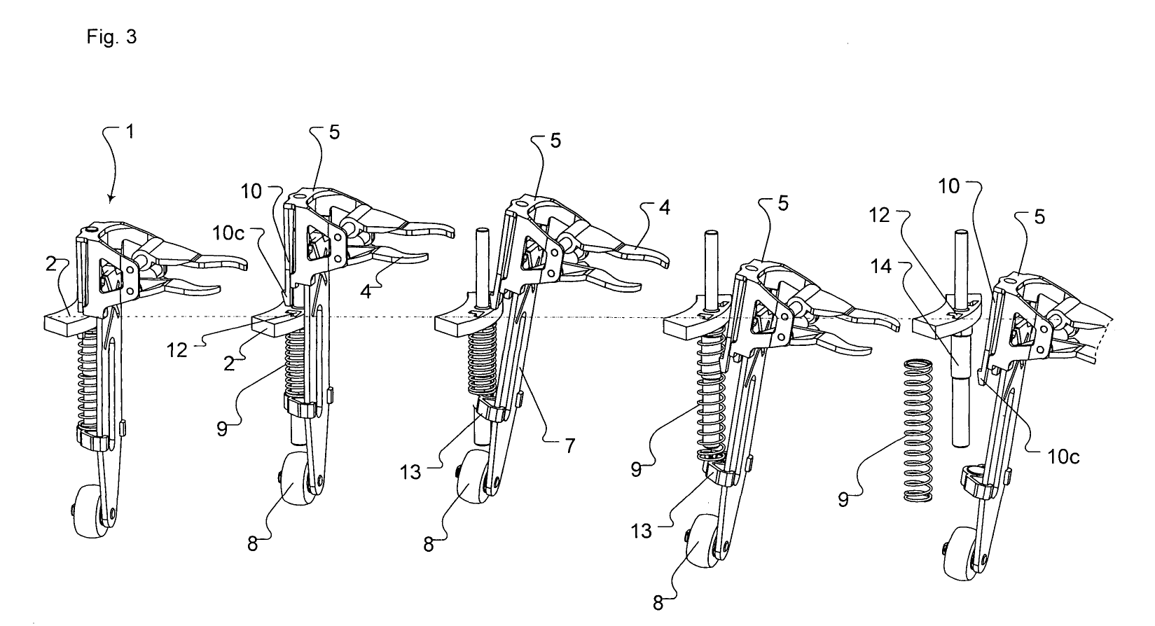

FIG. 3 shows five different stages of the unclipping of a gripping device according to the invention.

FIG. 1 shows a three-dimensional representation of a gripping device according to the invention, given the general reference 1, said gripping device being provided on a system element 2 so as to be replaceable, it being possible for the system element 2 to be realized as an element of a star of a bottle filling system or as a corresponding securing element on said machine parts, more details of which will follow.

The gripping device 1 according to the invention is used, as can also be seen in FIGS. 1 and 2, for the active gripping of PET bottles 3 in the neck region of said bottles.

To grip the PET bottles 3, the gripping device 1 is provided with two actively moveable gripping arms 4a and 4b, which are located so as to be displaceable laterally in a bearing element, given the general reference 5, the bearing bolts, given the reference 6, being secured there simply by means of clipping-on with no screw connections. The respective fixing points are given the reference 6a in FIG. 2.

Next to the sliding bolts 6 on their side remote from the gripping regions, the gripping arms 4 have shoulders guided in linkage surfaces, which is not shown in detail in the Figures. The movement of the gripping arms is effected by a pusher body 7, which is provided with a roller 8, which triggers the opening and closing movement of the gripping arms 4 in opposition to the force of a spring 9 via a linkage surface not shown in detail.

Essential to the invention is that the bearing element 5 with the gripping arms 4 guided therein, including the pusher element 7 with roller 8 and spring 9, can be detachably connected to the bearing element by means of a clip-on connection.

Said clip-on connection, given the general reference 10, can be developed variously, FIGS. 1 and 2 each showing two clips 10a and 10b that are fitted onto locking webs 11 on the bearing element 5, securing the same.

FIG. 3 shows a somewhat modified exemplary embodiment of just this clip-on connection, all components in FIG. 3 being provided with references that are identical to those in the exemplary embodiment in FIG. 1.

FIG. 3 shows another exemplary embodiment of the invention in different sequence steps, in this case the clips 10′ forming an integral component of the bearing element 5, they are, as can be seen in FIG. 3, directed downward and engage by way their locking shoulders 10c in recesses 12, which are admitted into the corresponding system element 2.

The left representation in FIG. 3 shows the operating position of the gripping device 1 according to the invention locked on the system element 2, the second image shows the first step of the unclipping process in which the locking shoulders 10c have already been lifted out of the corresponding openings 12. At the same time, through the pulling upward the spring 9 is compressed by such an amount until the bearing element 5 can be completely lifted out. The bearing element 5 is then displaced downward so that a guiding and holding shoulder 13, which is held on the pusher body so as to be displaceable but non-detachable, releases the spring 9, such that it can be pulled downward on its sliding bars and removed. Said sliding bar 14 is used with its upper part 14a as axis of rotation or guiding axis for the bearing element 5.

It can easily be seen in the above described Figures that the elements 2, 9 and 14 form one component assembly, the wear-free component assembly within the terms of this invention, which remains fixedly connected to the conveying element. The other component assembly, which is subjected to severe wear, is formed substantially by the elements 4 to 8 and 10 and can be released or attached as one unit or one complete component assembly without the need for any tooling.

Naturally, it is possible to modify the described exemplary embodiments of the invention in many respects without departing from the inventive concept. Thus, the locking lugs 10c can be developed in conjunction with the engagement slots 12 such that the bearing element 5 can also carry out horizontal pivotal movements over a certain distance and such like.

1. An apparatus for gripping containers in container processing systems, said apparatus comprising:
a first component assembly that includes components that are subject to severe wear, and
a second component assembly, said second component assembly being a machine-side assembly
having components that are not subject to wear, and
being pivotably mounted with the first component assembly so as to be interconnectable and easily separable therefrom.

2. The apparatus of claim 1,
wherein the first component assembly comprises: gripping arms and a pusher body with linkage surfaces that move the gripping arms, said first component assembly being associated with a common bearing element (5), and
wherein the second component assembly includes at least one sliding rod and a machine-side system element.

3. The apparatus of claim 2, wherein the bearing element associated with the first component assembly is detachably connectable to the second component assembly by a manually activatable locking connection.

4. The apparatus of claim 3, wherein the locking connection and the machine-side system element of the second component assembly are detachably connectable.

5. The apparatus of claim 2, further comprising locking clips for gripping and securing the gripping device, said locking clips being provided on one of the machine-side system element for the gripping device and on a side of the bearing element facing the machine-side system element.

6. The apparatus of claim 5, wherein the locking clips engage over a locking web on the bearing element.

7. The apparatus of claim 2, further comprising: clips provided at the bearing element for engaging corresponding recesses on the machine-side system element.

8. An apparatus for handling PET bottles, said apparatus comprising:
a conveying element; and
a plurality of gripping devices mounted on the conveying element, each of said gripping devices including
a first component assembly that includes components that are subject to severe wear, and
a second component assembly, said second component assembly being a machine-side assembly
having components that are not subject to wear, and
being pivotably mounted with the first component assembly so as to be interconnectable and easily separable therefrom.

9. The apparatus of claim 3, wherein said conveying element comprises a conveying star.

10. A method comprising:
gripping containers with one of a plurality of gripping devices located at a conveying device, each of said gripping devices including a first component assembly that includes components that are subject to severe wear, and a second component assembly, said second component assembly being a machine-side assembly having components that are not subject to wear, and being pivotably mounted with the first component assembly so as to be interconnectable and easily separable therefrom.

11. The method of claim 8, further comprising causing the at least one conveying device to rotate about a central axis, thereby causing the gripped container to rotate at least in an angular region about said central axis.

12. The apparatus of claim 1, wherein the first component assembly comprises gripper arms and a driving and actuating element.

13. The apparatus of claim 12, wherein the driving and actuating element comprises a push rod.

14. The method of claim 8, further comprising:
removing a container from one of said gripping devices;
pivoting said first component assembly to separate the first component assembly from the second component assembly;
obtaining a replacement component assembly;
pivoting said replacement component assembly into position so that said replacement component assembly interconnects with said second component assembly; and
causing said gripping device to grip a container.
